SEQUENCE LISTING (1 sequence)

SEQ ID NO: 1 - protein, 183 aa, Fusarium venenatum
MKFSATILSLLPAVLALPTGEDASVSKRQSVNTVTDQLLFSVTLPQFTARRNARDPPTVDWTSDGCTSSPDNPFGFPFIPACNRHDFGYHNYRAQSRFTVSAKSRIDNNFKTDLYFQCQSSSVSGVCRALADVYFAAVRAFGGDDATPGKRDEALVKEYEKKVEVYNKLVEEAQKKGDLPRLD

(19) United States
(12) Patent Application Publication
(10) Pub. No.: US 2026/0293926 A1
(43) Pub. Date: Oct. 1, 2026

(54) Method of Making a Food Product and Uses of a Phospholipase

(71) Applicant: CHR. HANSEN A/S, Hoersholm (DK)

(72) Inventors: Marc FAIVELEY, D'Ornon (FR); Martin LUND, Copenhagen (DK); Sebastien ROUSTEL, CHALON (FR)

(73) Assignee: CHR. HANSEN A/S, Hoersholm (DK)

(21) Appl. No.: 19/476,705

(22) PCT Filed: Apr. 29, 2024
(86) PCT No.: PCT/EP2024/061759

§ 371 Date: Oct. 19, 2025

(30) Foreign Application Priority Data
Apr. 28, 2023 (EP) 23170688.8

(51) Int. Cl. A23C 21/02; A23C 19/05; A23C 19/068

(52) U.S. Cl. CPC A23C 21/02; A23C 19/053; A23C 19/0686

(57) ABSTRACT

This disclosure relates to method for making a food product, such as a dairy product or cheese, wherein a phospholipase is used. The disclosure also relates to the use of the phospholipase to improve fat retention and/or protein retention in said process for making the food product.

### TECHNICAL FIELD

The present document generally relates to method for making a food product, such as a dairy product, preferably cheese, wherein a phospholipase is added either to cream or to whey cream, instead of milk as conventionally done. Further, this document also relates to the use of a phospholipase to improve fat retention and/or protein retention in said process for making the food product.

### BACKGROUND

Phospholipases can be used to improve cheese yield and cheese functionalities. The principle is based on lysophospholipids generated by a phospholipase from phospholipids contained at the surface of fat globules membrane. Lysophospholipids are surfactants and thus improve the fat retention in the curd by making smaller globules and by enhancing emulsification in curd matrix.

Phospholipases are used in cheese production for several years as they reduce the loss of fat and milk solids while increasing cheese yield. These enzymes, for example, a phospholipase A1 or A2, may be added directly to milk or standardized milk with a dosage of ~3-5 LEU-P/g milk fat, prior to start of the cheese making process, and let to react 20 min at 32° C., before adding rennet to the milk.

However, despite good results in terms of cheese yield (~1-2% moisture adjusted yield in average) when compared with a cheese made without the addition of the phospholipase, customers are always looking for ways to further improve cheese yield, that is ways of making more cheese out of the same volume of milk. Additionally, the use of phospholipases in cheese making has the disadvantage that said enzyme can be found in the whey, as pasteurization is not enough to remove residual enzyme. This is specially concerning when whey is processed for human food. Thus, whey is a valuable raw material, and it is relevant to preserve its value such that it can be converted into higher value products.

In conclusion, there is a need or desire to further increase cheese yields while simultaneously eliminating the amount of phospholipase in the whey.

### SUMMARY

The present document relates to a method for making a food product, such as a dairy product, preferably cheese, wherein a phospholipase is added either to cream or to whey cream, instead of milk as conventionally done. Surprisingly, the addition of a phospholipase to cream or whey cream (cream or whey cream are later used in cheese production) allows to add less enzyme, that is allows to add a lower dosage of enzyme, that what is standard in the art, while simultaneously maintaining or even increasing cheese yield. As a result, less, or none, residual enzyme is found in whey without compromising cheese yield, preferably when comparing to the use of phospholipase added directly to milk. Further, by applying the enzyme to cream or to whey cream, it is also possible to perform a second pasteurization with the purpose of eliminating any residual enzyme in the final whey, if any is still present. In contrast, if the phospholipase is added to milk, then a second pasteurization step is not possible to be carried out (with the purpose of eliminating residual enzyme in the whey) as it leads to a reduction of value of whey due to denaturation of whey proteins and to the formation of off flavors which are carried over to other products made out of the whey pasteurized twice.

### Process for Making a Food Product, Such as a Dairy Product or Cheese

This aspect relates to a process for making a food product comprising the following steps:
adding a phospholipase to cream and/or whey cream to obtain a phospholipase-treated cream and/or a phospholipase-treated whey cream;
adding the phospholipase-treated cream and/or phospholipase-treated whey cream to milk;
carrying out appropriate steps for preparing the food product.

In an embodiment, the step of adding the phospholipase-treated cream and/or phospholipase-treated whey cream to milk may be carried out by:
adding at most 20.0 g of the phospholipase-treated cream and/or phospholipase-treated whey cream per liter of milk; or
adding 0.2 and 20.0 g the phospholipase-treated cream and/or phospholipase-treated whey cream per liter of milk; or
adding 0.2-4.6 or 0.7-3.5 or 1.2-2.3 g the phospholipase-treated cream and/or phospholipase-treated whey cream per liter of milk, preferably if milk or standardized milk at 23 g_{fat}/Lₘᵢₗₖ is desired; or
adding 0.2-4.8 or 0.7-3.6 or 1.2-2.4 g the phospholipase-treated cream and/or phospholipase-treated whey cream per liter of milk, preferably if milk or standardized milk at 24 g_{fat}/Lₘᵢₗₖ is desired; or
adding 0.3-5.6 or 0.8-4.2 or 1.4-2.8 g the phospholipase-treated cream and/or phospholipase-treated whey cream per liter of milk, preferably if milk or standardized milk at 28 g_{fat}/Lₘᵢₗₖ is desired; or
adding 0.3-6.0 or 0.9-4.5 or 1.5-3.0 g the phospholipase-treated cream and/or phospholipase-treated whey cream per liter of milk, preferably if milk or standardized milk at 30 g_{fat}/Lₘᵢₗₖ is desired; or
adding 0.5-10.0 or 1.5-7.5 or 2.5-5.0 g the phospholipase-treated cream and/or phospholipase-treated whey cream per liter of milk, preferably if milk or standardized milk at 50 g_{fat}/Lₘᵢₗₖ is desired; or
adding 0.6-12.0 or 1.8-9.0 or 3.0-6.0 g the phospholipase-treated cream and/or phospholipase-treated whey cream per liter of milk, preferably if milk or standardized milk at 60 g_{fat}/Lₘᵢₗₖ is desired; or
adding 0.9-18.0 or 2.7-13.5 or 4.5-9.0 g the phospholipase-treated cream and/or phospholipase-treated whey cream per liter of milk, preferably if milk or standardized milk at 90 g_{fat}/Lₘᵢₗₖ is desired.

In an embodiment, the milk may have 90 or less than 90 g_{fat}/Lₘᵢₗₖ, preferably the milk may 23-90 g_{fat}/Lₘᵢₗₖ or 23-60 g_{fat}/Lₘᵢₗₖ or 23-30 g_{fat}/Lₘᵢₗₖ, more preferably 23-28 g_{fat}/Lₘᵢₗₖ or 25-28 g_{fat}/Lₘᵢₗₖ or 25-28 g_{fat}/Lₘᵢₗₖ or 24-26 g_{fat}/Lₘᵢₗₖ. The milk may be standardized milk or skimmed milk or standardized skimmed milk.

In an embodiment, the step of adding the phospholipase-treated cream and/or phospholipase-treated whey cream to milk may be a step of adding 0.2-2.7 g of the phospholipase-treated cream per liter of milk and/or phospholipase-treated whey cream per liter of milk. Preferably as step of adding 0.3-2.7 g of the phospholipase-treated cream per liter of milk and/or phospholipase-treated whey cream per liter of milk. More preferably a step of adding 0.8-1.4 g of the phospholipase-treated cream per liter of milk and/or phospholipase-treated whey cream per liter of milk.

In an embodiment, the step of adding the phospholipase-treated cream and/or phospholipase-treated whey cream to milk may be a step of adding 0.2-2.7 g of the phospholipase-treated cream per liter of milk and/or phospholipase-treated whey cream per liter of milk, and wherein the milk may have 28 g_{fat}/Lₘᵢₗₖ.

In an embodiment, the step of adding the phospholipase to cream and/or whey cream may be carried out by adding 1-15 Leu/g of fat of the phospholipase to cream and/or whey cream, preferably 2-12 or 2-10 or 2-7 or 3-5 Leu/g of fat of the phospholipase to cream and/or whey cream. In the context of the present document and aspect, Leu or Leu-P are used interchangeable. Preferably, Leu is determined as explained in Specifications prepared at the 65^{th} JECFA 2005, published in the Combined Compendium of Food Additive Specifications, Food and Agriculture Organization of the United Nations JECFA Monographs 1 of 2005.

In an embodiment, the phospholipase may be phospholipase A, such as phospholipase A1 (EC 3.1.1.32) or phospholipase A2 (EC 3.1.1.4): Preferably the phospholipase may have a sequence identity of at least 80% to SEQ ID NO: 1 or may have a sequence identity of at least 80% to amino acids 29 to 149 of SEQ ID NO: 1 or may have a sequence identity of at least 80% degree of identity to amino acids 29 to 183 SEQ ID NO: 1.

In an embodiment, the process may be a batch process or a continuous process.

In an embodiment, the step of adding the phospholipase to cream and/or whey cream may be carried out:
at a temperature of 2-10° C., such as 4° C., and for at least 12 h, such as for 12-24 h, preferably in a batch process; or
at a temperature of 25-42° C., such as 28-40° C. or 30-35° C. or 27-32° C., preferably 32° C., and for 10-30 min, such as 20-30 min, such at 32° C. for 20 min, preferably in continuous process.

In an embodiment, the step of heat treating the cream and/or whey cream may be carried out before the step of adding the phospholipase to the cream and/or whey cream.

In an embodiment, the process may further comprise a step of heat-treating the phospholipase-treated cream at 70° C.-90° C., such as 72° C.-87° C. or 82° C.-87° C. or 85° C.-87° C.

In an embodiment, the process may further comprise a step of pasteurizing the phospholipase-treated whey cream, the phospholipase-treated cream and/or pasteurizing whey obtained from the process for making a food product, preferably wherein the step of pasteurizing is carried out at 74° C. for 20 sec or within other ranges of temperature and time known to be pasteurization conditions.

In an embodiment, the milk used in this process may be selected from cow's milk, camel's milk, buffalo milk, goat's milk, sheep's milk, and/or a mixture thereof; and/or wherein the milk is skimmed milk; and/or wherein the milk is standardized milk or standardized skimmed milk.

In an embodiment, the process may further comprise a step of adding milk cream to standardize milk. Said milk cream may or may not be treated with the phospholipase.

In an embodiment, the food product may be a dairy product. Preferably it may be a dairy product selected from a cheese, a cheese product, a processed cheese, a cheese-like product, such as vegan cheese or non-dairy cheese, a butter, a yogurt, a cream, and a seasoning. More preferably the dairy product may be cheese selected from a list consisting of: Cheddar cheese, Saint-nectaire cheese, Morbier cheese, Chevrotin cheese, Gouda cheese, Raclette cheese, Fontina cheese, Manchego cheese, Cantal cheese, Laguiole cheese, Salers cheese, Abondance cheese, Appenzel cheese, Maasdam cheese, Beaufort cheese, Comté cheese, Parmesan cheese, Grana Padano cheese, Emmental cheese, Gruyère cheese, pasta filata, Mozzarela cheese and soft cheese.

In an embodiment, a coagulant or chymosin may be added to the process herein described.

Use of a Phospholipase to Improve Fat Retention and/or Protein Retention in a Process for Making a Food Product, Such as a Dairy Product or Cheese

This aspect relates to the use of a phospholipase to improve fat retention and/or protein retention in a process for making a food product.

In an embodiment, the food product may be a dairy product

In an embodiment, the dairy product may be selected from a cheese, a cheese product, a processed cheese, a cheese-like product, such as vegan cheese or non-dairy cheese, a butter, a yogurt, a cream, and a seasoning. Preferably, the dairy product may be cheese selected from a list consisting of: Cheddar cheese, Saint-nectaire cheese, Morbier cheese, Chevrotin cheese, Gouda cheese, Raclette cheese, Fontina cheese, Manchego cheese, Cantal cheese, Laguiole cheese, Salers cheese, Abondance cheese, Appenzel cheese, Maasdam cheese, Beaufort cheese, Comté cheese, Parmesan cheese, Grana Padano cheese, Emmental cheese, Gruyère cheese, pasta filata, Mozzarella cheese and soft cheese.

In an embodiment, the phospholipase may be added to cream and/or whey cream to obtain a treated cream and/or a treated whey cream.

In an embodiment, 1-15 Leu/g of fat of the phospholipase may be added to cream and/or whey cream, preferably 2-10 or 2-7 or 3-5 Leu/g of fat of the phospholipase to cream and/or whey cream. In the context of the present document and aspect, Leu or Leu-P are used interchangeable. Preferably, Leu is determined as explained in Specifications prepared at the 65^{th} JECFA 2005, published in the Combined Compendium of Food Additive Specifications, Food and Agriculture Organization of the United Nations JECFA Monographs 1 of 2005.

In an embodiment, the phospholipase may be phospholipase A, or phospholipase A1 (EC 3.1.1.32), or phospholipase A2 (EC 3.1.1.4). Preferably, the phospholipase may have a sequence identity of at least 80% to SEQ ID NO: 1 or may have a sequence identity of at least 80% to amino acids 29 to 149 of SEQ ID NO: 1 or may have a sequence identity of at least 80% degree of identity to amino acids 29 to 183 SEQ ID NO: 1.

### Definitions

As used herein, the following definitions apply.

Milk is often standardized before cheese making to optimize the protein to fat ratio to make a good quality cheese with a high yield. In the context of the present document, “standardization” or “standardization of milk”, used interchangeably, refer to the adjustment (raising or lowering) of milk fat content of milk alone or together with solids non-fat (SNF) to prepare different varieties of milk. Standardization is important in the dairy industry as it ensures that every consumer gets milk with constant fat content and process consistency.

Cheese is normally made by standardizing the fat content of the milk raw material at a desired level.

The most used method in the industry is to separate the entire amount of milk into skimmed milk and cream, and to use an amount of the cream to add the required fat content to the milk to be used for cheese making. The same may be done by mixing skim (fat-free) milk and full fat milk at a desired ratio.

“Cream” is obtained when the whole milk supplied to the separator is discharged as two flows, skimmed milk (about 0.03% fat), and cream with high fat content (about 30-45%, according to the parameters of the separation step). Cream usually represents about 10% of the total throughput. The proportion discharged as cream determines the fat content of the cream.

“Whey” is collected in a process of cheese making after curd cutting. Whey comprises 80-90% of the total volume of milk entering the process and contains about 50% of the nutrients in the original milk: soluble protein, lactose, vitamins and minerals. Whey is a by-product from the manufacture of rennet types of hard, semi-hard or soft cheese and has a pH of 5.9-6.6. Whey is also known as sweet whey.

“Whey cream” is composed of milk fat and whey (serum portion). Whey cream is the result of whey centrifugation which allows for the fat to be concentrated, like what is done for milk cream, such that whey cream gets a close concentration comparing to milk cream of approx. 30-35%. Often, whey cream has a fat content of 25-35%, and can be, at least, partly reused in cheese-making to standardize the cheese milk. Normally, this works well for short maturation cheeses such as mozzarella. However, the risk of rancid off flavors is heightened as the maturation time is increased. Whey cream is generally heat treated (90° C. for 30 min) due to the sensitivity of the starter culture to bacteriophages.

“Phospholipase” is an enzyme that plays a role in the metabolism of phospholipids. The phospholipase which may be used for the present application includes phospholipase A such as phospholipase A1 (EC 3.1.1.32) and phospholipase A2 (EC 3.1.1.4), phospholipase B (EC 3.1.1.5), phospholipase C (EC 3.1.4.3) and phospholipase D (EC 3.1.4.4). Phospholipases A1 (EC 3.1.1.32) and A2 (EC 3.1.1.4) are considered carboxylic ester hydrolases (EC 3.1.1), meaning that they cleave the same bond C—O in R₁—O═C—O—R₂ but they do it in different parts of the substrate.

The phospholipase may be of any origin, e.g., of animal origin (such as, e.g., mammalian), e.g., from pancreas (e.g., bovine or porcine pancreas), or snake venom or bee venom. Alternatively, the phospholipase may be of microbial origin, e.g. from filamentous fungi, yeast or bacteria, such as the genus or species Aspergillus, e.g., A. niger; Dictyostelium, e.g. D. discoideum; Mucor, e.g. M. javanicus, M. mucedo, M. subtilissimus; Neurospora, e.g. N. crassa; Rhizomucor, e.g. R. pusillus; Rhizopus, e.g. R. arrhizus, R. japonicus, R. stolonifer; Sclerotinia, e.g. S. libertiana; Trichophyton, e.g. T. rubrum; Whetzelinia, e.g. W. sclerotiorum; Bacillus, e.g. B. megaterium, B. subtilis; Citrobacter, e.g. C. freundii; Enterobacter, e.g. E. aerogenes, E. cloacae; Edwardsiella, e.g. E. tarda; Erwinia, e.g. E. herbicola; Escherichia, e.g. E. coli; Klebsiella, e.g. K. pneumoniae; Proteus, e.g. P. vulgaris; Providencia, e.g. P. stuartii; Salmonella, e.g. S. typhimurium; Serratia, e.g. S. liquefasciens, S. marcescens; Shigella, e.g. S. flexneri; Streptomyces, e.g. S. violeceoruber; Yersinia, e.g. Y. enterocolitica. The phospholipase may be fungal, e.g., from the class Pyrenomycetes, such as the genus Fusarium, such as a strain of F. culmorum, F. heterosporum, F. solani, F. venenatum, or a strain of F. oxysporum. The phospholipase may also be from a filamentous fungus strain within the genus Aspergillus, such as a strain of Aspergillus awamori, Aspergillus foetidus, Aspergillus japonicus, Aspergillus niger or Aspergillus oryzae. A preferred phospholipase is derived from a strain of Fusarium, particularly from F. venenatum or F. oxysporum, e.g., from strain DSM 2672 as described in WO 98/26057, especially described in claim 36 of WO 98/26057. In further embodiments, the phospholipase is a phospholipase as disclosed in WO 00/32758 (Novozymes A/S, Denmark). Another preferred phospholipase A is phospholipase A2 from Streptomyces, such as e.g., PLA2 from S. violaceoruber or a phospholipase as described in EP3078741.

Phospholipases are commercially available under different names, such as YieldMax® (Chr. Hansen A/S, Denmark), Lecitase® Ultra and Lecitase®10 L (both from Novozymes A/S, Denmark), Maxapal® A2 (DSM Food Specialties, The Netherlands), CakeZyme® and BakeZyme® (DSM Food Specialties, The Netherlands), Rohalase® MPL (AB Enzymes, Germany) and LysoMax® (Genencor, USA).

Other food-grade phospholipases are well known to a skilled person in the art and can be found for example in Casado, Victor, et al. “Phospholipases in food industry: a review.” Lipases and Phospholipases: Methods and Protocols (2012): 495-523.

“Phospholipase activity”, such as “phospholipase A1 activity”, is measured relative to a phospholipase standard using lecithin as a substrate. The enzyme catalyzes the hydrolysis of lecithin to lyso-lecithin and a free fatty acid. The liberated fatty acid is titrated with 0.1 N sodium hydroxide under standard conditions (pH=8.0; 40° C.±0.5). The activity of the enzyme is determined as the rate of sodium hydroxide consumption during neutralization of the fatty acid and is expressed in Lecitase units (Leu) relative to a Lecitase (phospholipase) standard.

“1 Leu” is defined as the amount of enzyme that under standard conditions (pH=8.0; 40° cf0.5) results in the same rate of sodium hydroxide consumption (in microeq/min) as the Lecitase standard diluted to a nominal activity of 1 Leu/g. The quantification limit of the method is approximately 1.5 Leu/ml. The method can be carried out using either an automated system or standard laboratory equipment for carrying out titration experiments. Procedures and calculations for both the automated and manual versions are described. Further details can be found in the Specifications prepared at the 65^{th} JECFA (2005), published in the Combined Compendium of Food Additive Specifications, Food and Agriculture Organization of the United Nations (FAO) JECFA Monographs 1 (2005). Alternatively, details can also be found in “Safety evaluation of the food enzyme phospholipase A1 from the genetically modified Aspergillus oryzae strain NZYM-PP” published on EFSA Journal 2023; 21(2):7835. Alternatively, and as explained in par. 47 or in par. 120-122, both passages disclosed in US2004/0253680 A1, phospholipase activity may e.g., be measured in the LEU assay by hydrolyzing soy lecithin (L-alfa-phosphotidyl-choline) at pH 8.0 and 40° C. for 2 minutes. Phospholipase activity is expressed as the rate of titrant consumption (0.1 M NaOH) necessary for keeping constant pH, relative to a standard. Identical passages can also be found in WO2004/097012. Finally, determining the phospholipase activity is well known in the art.

“Economical Cheese Yield” or ECY is adjusted to give “Moisture Adjusted Cheese Yield” or MACY by measuring the dry matter after ripening. MACY is calculation by adjusting dry matter (DM) as follows: ECY×DM of trial %/DM of reference %. Briefly, the yield adjusted on moisture was then used to remove the water retention effect on cheese yield.

“Moisture Adjusted Cheese Yield” or MACY can also by divided by the fat and protein into the milk to take into account the composition of the milk used, in terms of fat and protein, which may not be the same between different trials.

In the context of the present invention or disclosure, Continental cheese may be a pressed uncooked cheese, a semi-cooked and pressed cheese or a pressed and cooked cheese. Examples of a pressed uncooked cheeses is: Saint-nectaire, Morbier, Chevrotin, Gouda, Raclette, Fontina, Manchego, Cantal, Laguiole, Salers, or Cheddar. Examples of a semi-cooked and pressed cheeses is: Abondance, Appenzel, or Maasdam. Examples of a pressed and cooked cheeses is: Beaufort, Comté, Parmesan, Grana Padano, Emmental, Gruyère.

In the context of the present invention or disclosure, Mozzarela cheese can be defined as pizza cheese.

“Standardization” of milk is known in the food industry, for example, in the cheese industry. Depending on the cheese type the standardization may vary. For example, for Continental cheese as above defined (or Continental-type of cheese as above defined) a fat/protein ratio of 0.8-1 and a protein content of 3.2%-5% may be considered, such that the total fat is 2.6%-5%. For soft cheese (or soft-type cheese) a fat/protein ratio of 1-1.7 and a protein content of 3.2%-5.5% may be considered, such that the total fat is 3.3% to 8.5%. For pasta filata cheese (or pasta-filata type of cheese) a fat/protein ratio of 0.8 to 1.1 and a protein content from 3.2%-6% may be considered, such that is 2.6% to 6.6%. Standardization of milk to produce low-fat cheese is also known.

### DETAILED DESCRIPTION

The present document relates to a method for making a food product, such as a dairy product, preferably cheese, wherein a phospholipase is added either to cream or to whey cream, instead of milk as conventionally done. The addition of the enzyme in cream or in whey cream allows for the reduction or absence of residual phospholipase in the whey obtained from cheese making while maintaining or even improving cheese yield compared to when the enzyme is added to milk.

To have phospholipase in whey, even if a residual amount of phospholipase, is disadvantageous, at least, for the following reasons: 1) a pasteurization step is not enough to remove residual enzyme from the whey and a more several heat-treating step is undesired as it can cause off flavor in the whey; and 2) whey is a valuable raw material, and it is relevant to preserve its value such that it can be converted into higher value products. This is especially problematic when there is a wish to process whey for human food. Thus, whey is a valuable raw material, and it is relevant to preserve its value such that it can be converted into higher value products.

The examples may be carried out with any of the phospholipases above mentioned. Alternatively, a polypeptide comprising an amino acid sequence which has at least 80% degree of identity to SEQ ID NO: 1 or a polypeptide comprising an amino acid sequence which has at least 80% degree of identity to amino acids 29 to 149 SEQ ID NO: 1 can be used or a polypeptide comprising an amino acid sequence which has at least 80% degree of identity to amino acids 29 to 183 SEQ ID NO: 1, preferably provided the phospholipase is added to cream or whey cream in a concentration from 1-10 Leu/g of milk fat, preferably 3-8 Leu/g of milk fat, more preferably 5-7 Leu/g of milk fat. Further, determining how much to add of a phospholipase in Leu/g of milk fat or Leu-P/g of milk fat is known, at least from the art documents mentioned above.

### EXAMPLES

### Example 1—Addition of Phospholipase to Whey Cream

Whey cream was obtained by concentrating fat in whey. This step may be carried out such that ~300-350 g/l of fat in whey is obtained (or 30-35%), for example 320 g/l of fat in whey (or 32%). Means to conduct this step are well known in the art.

Whey cream was subsequently heat-treated at 90° C. for 20-30 min to remove phages and subsequently stored at cold temperature overnight, which may be a temperature from 2° C.-10° C., such as 4-8° C. Alternative ranges of temperature and time can be considered and are known in the art.

At this stage, the whey cream was equally divided in sample 1 and reference. A phospholipase (YieldMax® from Chr. Hansen A/S) was added to sample 1 in a concentration of 5 Leu/g of milk fat or 5 Leu-P/g of milk fat, while no phospholipase was added to the reference.

The whey cream treated with the phospholipase (sample 1) can be named as “treated whey cream” or “phospholipase-treated whey cream”. This applies to all examples herein presented where a phospholipase is added to whey cream.

Each vat used in Example 1 was filled at 2600 liters of milk. The ratio of fat/protein was of 0.85 fat/protein ratio and the milk total fat content was standardized at 28 g_{fat}/Lₘᵢₗₖ or 2,8% (2.8 g fat per 100 ml of milk). A standardization of milk of at least 23 g_{fat}/Lₘᵢₗₖ, such as 23 to 30 g_{fat}/Lₘᵢₗₖ, preferably 23 to 30 g_{fat}/Lₘᵢₗₖ or 24 to 28 g_{fat}/Lₘᵢₗₖ, is acceptable.

The treated whey cream (sample 1) was then incorporated into the milk in different percentages leading to samples 1A and 1B.

Sample 1A corresponds to the addition of treated whey cream into milk such that 5% of total fat in milk is provided by said treated whey cream. In other words, 3.64 kg of treated whey cream was added to a vat of 2600 liters part skimmed milk (1.4 g of treated whey cream was added to 1 liter of skimmed milk) to get a standardized milk with 26.6 g_{fat}/Lₘᵢₗₖ.

Sample 1B corresponds to the addition of treated whey cream into milk such that 15% of total fat in milk is provided by said treated whey cream. In other words, 10.92 kg of treated whey cream was added to a vat of 2600 liters part skimmed milk (4.2 g of treated whey cream was added to 1 liter of skimmed milk) to get a standardized milk with 23.8 g_{fat}/Lₘᵢₗₖ.

The non-treated whey cream (reference) was equally incorporated into skimmed milk in a concentration of 5% of total fat in milk. In other words, 3.64 kg of non-treated whey cream was added to a vat of 2600 liters part skimmed milk (1.4 g of non-treated whey cream was added to 1 liter of skimmed milk) to get a standardized milk with 26.6 g_{fat}/Lₘᵢₗₖ.

A sample corresponding to the addition of treated whey cream into milk such that 10% of total fat in milk is provided by said treated whey cream could also be prepared. In other words, 7.28 kg of treated whey cream was added to a vat of 2600 liters part skimmed milk (2.8 g of treated whey cream was added to 1 liter of skimmed milk) to get a standardized milk with 25.2 g_{fat}/Lₘᵢₗₖ. Similar calculations can also be performed if a sample corresponding to the addition of treated whey cream into milk such that 1%, 3%, 7%, 12% or 20% is to be prepared. Similar calculations can also be made for soft cheese or pasta filata cheese, considering the fat/protein ratio and protein content as described in above.

Samples 1A, 1B, and reference were subsequently pasteurized at 74° for 20 sec. Optionally, milk cream can also be added and contribute to the standardization of milk. Upon pasteurization, the samples were used for cheese making, in particular Continental cheese making, wherein Continental cheese may be selected from a list consisting of: Saint-nectaire cheese, Morbier cheese, Chevrotin cheese, Gouda cheese, Raclette cheese, Fontina cheese, Manchego cheese, Cantal cheese, Laguiole cheese, Salers cheese, Cheddar cheese, Abondance cheese, Appenzel cheese, Maasdam cheese, Beaufort cheese, Comté cheese, Parmesan cheese, Grana Padano cheese, Emmental cheese and Gruyère cheese. During the cheese making process, a pasteurization (that is a further pasteurization in the process) of whey can be made to decrease or eliminate residual phospholipase in the whey, if any.

### Fat and Protein Recovery & Cheese Yield

TABLE 1
Percentage of fat recovery, protein recovery and cheese
yield quantification (ECY and MACY) versus the reference.

| | | |
|---|---|---|
| Reference | Sample 1A | Sample 1B |

At demolding

| | | | |
|---|---|---|---|
| Fat recovery | 96.4 | 101.2 | 97.5 |
| Protein recovery | 80.4 | 86.2 | 78.8 |
| % ECY vs. ref | 0 | 6.4 | 3.2 |
| % MACY vs. ref | 0 | 8.5 | −1.1 |
| % MACY/prot + fat vs. ref | 0 | 5.9 | −0.3 |

Day 7 after demolding

| | | | |
|---|---|---|---|
| Fat recovery | 99.0 | 102.4 | 100.5 |
| Protein recovery | 80.8 | 84.9 | 80.1 |
| % ECY vs. ref | 0 | 7.6 | 2.2 |
| % MACY vs. ref | 0 | 7.6 | 0.0 |
| % MACY/prot + fat vs. ref | 0 | 5.0 | 0.9 |

Day 21 after demolding

| | | | |
|---|---|---|---|
| Fat recovery | 99.3 | 102.9 | 98.6 |
| Protein recovery | 78.3 | 83.7 | 79.0 |
| % ECY vs. ref | 0 | 6.2 | 1.0 |
| % MACY vs. ref | 0 | 8.7 | 0.9 |
| % MACY/prot + fat vs. ref | 0 | 6.1 | 1.8 |

Table 1 demonstrates the effect of adding phospholipase-treated whey cream to milk or standardized milk. Table 1 displays:
higher levels of fat and protein were recovered with sample 1A vs. the reference and sample 1B, independently from the ripening time;
an increase in cheese yield when sample 1A is used vs. the reference and sample 1B, independently from the ripening time;
an increase in cheese yield when sample 1B is used vs. the reference, in particular when the ripening time is more than 7 days, such as 21 days.

The higher levels of fat and protein recovered, and the better moisture retention may justify the increase in cheese yield.

### Losses in Whey

Whey samples, obtained from the cheese making process, were also evaluated for fat and protein losses. Whey samples were monitored before whey off and water addition (curd washing). The values were corrected by % of losses/g of lactose remove by drainage. Determining protein and fat losses are known in the art.

TABLE 2
Percentage of fat and protein losses in whey.

| | Reference | Sample 1A | Sample 1B |
|---|---|---|---|
| Fat losses in whey vs. ref | 0 | −5.9 | −16.5 |
| Protein losses in whey vs. ref | 0 | −1.5 | −1.8 |

Table 2 shows the losses in whey are lower for all samples. These results are aligned to CoaguSens™ analysis (data not shown).

### Water Activity and Cheese Quality

Water activity helps to predict the cheese quality over time. This descriptor can be approached by the moisture fat free basis (MFFB %).

TABLE 3
Percentage of moisture fat free basis (MFFB).

| MFFB % | Reference | Sample 1A | Sample 1B |
|---|---|---|---|
| At demolding | 62.7 | 62.1 | 64.8 |
| Day 21 after demolding | 61.2 | 60.2 | 60.7 |
| difference | 1.5 | 1.9 | 4.1 |

Table 3 shows that sample 1B has a higher water retention; however, the water retained is released (~4%) along ripening. In contrast, the trial made with sample 1A shows a release of water of less than

### Sensory Analysis

A sensory analysis was carried out with nine judges. The judges were trained for tasting cheese following the criteria: appearance, texture, taste, and flavor. The standard deviation is 1.6 between judges for the same criteria and for all criteria.

TABLE 4

| Appearance | Reference | Sample 1A | Sample 1B |
|---|---|---|---|
| Aspect | 1.6 | 2.2 | 2.1 |
| Crust | 3.0 | 3.6 | 3.2 |
| Color | 1.7 | 2.2 | 2.3 |

Texture

| | | | |
|---|---|---|---|
| Elasticity | 3.8 | 5.0 | 4.4 |
| Firmness | 4.7 | 4.4 | 4.7 |
| Adhesiveness | 1.3 | 1.6 | 1.2 |
| Melting | 2.1 | 2.5 | 2.5 |

Taste

| | | | |
|---|---|---|---|
| Bitterness | 1.8 | 2.1 | 1.9 |
| Acid | 1.9 | 2.8 | 2.4 |
| Sweet | 0.6 | 0.7 | 0.9 |
| Piquant | 0.8 | 0.9 | 0.6 |

Flavor

| | | | |
|---|---|---|---|
| Intensity | 3.1 | 4.5 | 3.7 |
| Lactic | 4.1 | 4.6 | 3.9 |
| Fruity | 1.6 | 2.5 | 2.1 |

Table 4 shows improved elasticity, acidity and fruity notes of cheeses made with sample 1A vs. the reference, while cheeses made with samples 1B seem to have more color, higher crust thickness, maybe due to a higher moisture content. However, this is still acceptable in the industry.

### Residual Amount of Phospholipase in Whey

One of the purposes of using a phospholipase in whey cream instead of milk is to reduce the residual amount in the whey, while simultaneously maintaining or increasing cheese yield.

The residual activity of the enzyme can be determined as described above or using a commercial non-esterified fatty acids (NEFA) assay, for example from Wako-Chemicals or Fujifilm.

TABLE 5
Residual activity.

LEU/ml

| | Milk | Serum | Pasteurized Serum |
|---|---|---|---|
| Reference #1 | 0.002 | −0.002 | −0.006 |
| Reference #2 | 0.003 | −0.006 | −0.010 |
| Sample 1A #1 | 0.010 | 0.003 | −0.003 |
| Sample 1A #2 | 0.014 | 0.001 | −0.009 |
| Sample 1B #1 | 0.030 | 0.015 | −0.002 |
| Sample 1B #2 | 0.021 | 0.004 | −0.003 |

The results found are below detection limit of the method but aligned with theory, that is 0,002 LEU/ml remain, in average, in the whey. After whey pasteurization (serum pasteurization), it was not possible to quantify the residual enzyme level as the levels were below the detection levels. In conclusion, the method wherein disclosed allows to reduce the residual activity of the enzyme in whey by 20.

### Example 2—Addition of Phospholipase to Cream

Cream was obtained by skimming raw milk. This step may be carried out such that ~300-350 or 350-400 g/l of fat in cream is obtained (30-35% or 35-40%). Means to conduct this step are well known in the art.

Cream was subsequently heat-treated at 90° C. for 20-30 min to remove phages and subsequently stored at cold temperature overnight, which may be a temperature from 2° C.-10° C., such as 4-8° C. Alternative ranges of temperature and time can be considered and are known in the art.

A phospholipase (YieldMax® from Chr. Hansen A/S) was added to milk in a concentration of 5-10 Leu/g of milk fat or 5-10 Leu-P/g of milk fat, such that a standardization of 3% of milk fat was obtained—sample 2.

The phospholipase was also added to cream with 38% fat content in a concentration of 5 Leu/g of milk fat or 5 Leu-P/g of milk fat (according to the user instructions)—sample 3.

In either case, the enzyme may be added at 32° C. and let to react for 20 minutes.

Cream treated with the phospholipase can be named as “treated cream” or “phospholipase-treated cream”. This applies to all examples herein presented where a phospholipase is added to cream.

Sample 3 was subsequently divided in samples 3.1, 3.2 and 3.3. Samples 3.2 and 3.3 were subsequently heat treated at 72° C. and 87° C., respectively, for example for 10 min in a water bath. Sample 3.1 remained unheated.

Cheeses was made in the small scale from milk acidified with hydrochloric acid to pH 6.5 and added calcium chloride and coagulant, using the samples above. Briefly, cheeses were made in disposable 50 ml centrifuge tubes placed in a thermoshaker heated to 32° C. A volume of 25 ml cheese milk was added 75 μl 1 M HCl to adjust pH of milk to 6.5. After heating to 32° C., a coagulant such as a chymosin was added to a dosage of 0.04 IMCU/ml and the tubes were shaken. Several chymosins are available on the market and are known to the skilled person. After 40 min of renneting shaking was stopped and curd cut using a spatula. The tube was shaken for 60 min at 32° C. and finally curd and whey separated by centrifugation at 3900 rpm for 20 min in a swinging bucket type centrifuge. Phospholipase activity was analysed using a commercial non-esterified fatty acids (NEFA) assay, for example from Wako-Chemicals or Fujifilm. Curd was extracted in water before enzyme analysis.

Result of phospholipase activity of curd and whey made in samples 2, 3.1, 3.2 and 3.3 are shown in Table 6.

TABLE 6
Residual activity of phospholipase in curd and whey.

| | Cheese | Whey |
|---|---|---|
| | curd (LEU/g) | (LEU/ml) |
| Sample 2 (milk) | 0.032 | 0.084 |
| Sample 3.1 (cream non-heated cream) | 0.032 | 0.099 |
| Sample 3.2 (cream treated at 72° C.) | 0.017 | 0.026 |
| Sample 3.3 (cream treated at 87° C.) | 0.024 | 0.011 |

Table 6 shows that when the phospholipase was dosed at the same activity per amount of fat, resulting residual activity in whey and curd was the same, irrespective of whether cream or cheese milk was treated with the enzyme (samples 2 and 3.1).

However, residual phospholipase activity in whey is influenced by heating the phospholipase-treated cream, at least to a range of 70° C.-90° C., such as 72° C.-87° C. or 82° C.-87° C. or 85° C.-87° C. Sample 3.2 shows a residual activity in whey of ~26% compared to sample 3.1 in whey. Sample 3.3 shows a residual activity in whey of ~11% compared to sample 3.1. Additionally, residual phospholipase activity is also influenced depending on if the enzyme is added to milk or to heat-treated cream. Sample 3.2 shows a residual activity in whey of ~31% compared to sample 3.1 in whey. Sample 3.3 shows a residual activity in whey of ~13% compared to sample 3.1.

### Example 3—Addition of Phospholipase to Whey Cream

Example 3 was carried out similarly to Example 1 with the following exceptions. At this stage, the whey cream was equally divided in samples 4.1, 4.2, 4.3 and reference. A phospholipase (YieldMax© from Chr. Hansen A/S) was added to samples 4.1, 4.2, 4.3 in a concentration of 2,5, 5 or 10 Leu/g of milk fat (or 2.5, 5 or 10 Leu-P/g of milk fat), respectively. No phospholipase was added to the reference.

Each vat used in Example 3 was filled at 2600 liters of milk (as in Example 1). The ratio of fat/protein was of 0.85 fat/protein ratio and the milk total fat content was standardized at 28 g_{fat}/Lₘᵢₗₖ or 2.8% (2.8 g fat per 100 ml of milk). A standardization of milk of at least 23 g_{fat}/Lₘᵢₗₖ, such as 23 to 30 g_{fat}/Lₘᵢₗₖ, preferably 23 to 30 g_{fat}/Lₘᵢₗₖ or 24 to 28 g_{fat}/Lₘᵢₗₖ, is acceptable.

The treated whey cream (samples 4.1, 4.2 or 4.3) was then incorporated into the milk such that 5% of total fat in milk is provided by said treated whey cream. In other words, 3.64 kg of treated whey cream was added to a vat of 2600 liters part skimmed milk (1.4 g of treated whey cream was added to 1 liter of skimmed milk) to get a standardized milk with 26.6 g_{fat}/Lₘᵢₗₖ. Alternatively, other % of total fat may be used.

The non-treated whey cream (or reference) was equally incorporated into skimmed milk in a concentration of 5% of total fat in milk. In other words, 3.64 kg of non-treated whey cream was added to a vat of 2600 liters part skimmed milk (1.4 g of non-treated whey cream was added to 1 liter of skimmed milk) to get a standardized milk with 26.6 g_{fat}/Lₘᵢₗₖ. Alternatively, other % of total fat may be used.

Samples 4.1, 4.2, 4.3 and reference were subsequently pasteurized at 74° for 20 sec. Alternatively, other suitable pasteurization conditions may also be used. Optionally, milk cream can also be added and contribute to the standardization of milk. Upon pasteurization, the samples were used for cheese making, in particular Continental cheese making, wherein Continental cheese may be selected from a list consisting of: Saint-nectaire cheese, Morbier cheese, Chevrotin cheese, Gouda cheese, Raclette cheese, Fontina cheese, Manchego cheese, Cantal cheese, Laguiole cheese, Salers cheese, Cheddar cheese, Abondance cheese, Appenzel cheese, Maasdam cheese, Beaufort cheese, Comté cheese, Parmesan cheese, Grana Padano cheese, Emmental cheese and Gruyère cheese. During the cheese making process, a pasteurization (that is a further pasteurization in the process) of whey can be made to decrease or eliminate residual phospholipase in the whey, if any.

### Fat and Protein Recovery & Cheese Yield

TABLE 7
Percentage of fat recovery, protein recovery and cheese
yield quantification (ECY and MACY) versus the reference.

| | Sample | Sample | Sample |
|---|---|---|---|
| Reference | 4.1 | 4.2 | 4.3 |

At demolding

| | | | | |
|---|---|---|---|---|
| % ECY vs. ref | 0 | 2.4 | 2.2 | 2.1 |
| % MACY vs. ref | 0 | 4.1 | 4.2 | 2.3 |
| % MACY/prot + fat vs. ref | 0 | −0.8 | −0.8 | 1.9 |

Day 21 after demolding

| | | | | |
|---|---|---|---|---|
| Fat recovery | 88.5 | 91.4 | 94.3 | 89.6 |
| Protein recovery | 73.1 | 75.2 | 79.3 | 78.6 |
| % ECY vs. ref | 0 | −2.2 | 0.9 | −1.8 |
| % MACY vs. ref | 0 | 1.8 | 5.3 | 3.0 |
| % MACY/prot + fat vs. ref | 0 | 2.4 | 5.6 | 5.4 |

Table 7 demonstrates the effect of adding phospholipase-treated whey cream to milk or standardized milk. Table 7 displays:
higher levels of fat and protein were recovered with samples treated with the phospholipase (samples 4.1, 4.2 and 4.3) vs. the reference at day 21 after demolding
   this tendency is aligned with the data shown in Table 1, which also shows higher levels of fat and protein at day 21 after demolding
an increase in cheese yield when samples treated with the phospholipase (samples 4.1, 4.2 and 4.3) are used at demolding vs. reference;
an increase in % MACY vs. reference when samples treated with the phospholipase (samples 4.1, 4.2 and 4.3) are used, preferably improved cheese yield when sample 4.2 is used at day 21 after demolding.

### Example 4—Addition of Phospholipase to Cream

Example 4 was carried out similarly to Example 2, with the following exceptions. The cream was equally divided in samples 5.1, 5.2, 5.3 and reference. A phospholipase (YieldMax® from Chr. Hansen A/S) was added to samples 5.1, 5.2, 5.3 in a concentration of 2.5, 5 or 10 Leu/g of milk fat (or 2.5, 5 or 10 Leu-P/g of milk fat), respectively. The enzyme may be added at 32° C. and let to react for 20 minutes. No phospholipase was added to the reference.

Each vat used in Example 4 was filled at 2600 liters of milk (as in Examples 1 and 3). The ratio of fat/protein was of 0.85 fat/protein ratio and the milk total fat content was standardized at 28 g_{fat}/Lₘᵢₗₖ or 2.8% (2.8 g fat per 100 ml of milk). A standardization of milk of at least 23 g_{fat}/Lₘᵢₗₖ, such as 23 to 30 g_{fat}/Lₘᵢₗₖ, preferably 23 to 30 g_{fat}/Lₘᵢₗₖ or 24 to 28 g_{fat}/Lₘᵢₗₖ, is acceptable.

The treated cream (samples 5.1, 5.2 or 5.3) was then incorporated into the milk such that 10% of total fat in milk is provided by said treated cream. 7.28 kg of treated whey cream was added to a vat of 2600 liters part skimmed milk (2.8 g of treated whey cream was added to 1 liter of skimmed milk) to get a standardized milk with 25.2 g_{fat}/Lₘᵢₗₖ. Alternatively, other % of total fat may be used.

The non-treated whey cream (or reference) was equally incorporated into skimmed milk in a concentration of 10% of total fat in milk. In other words, 37.28 kg of non-treated whey cream was added to a vat of 2600 liters part skimmed milk (2.8 g of non-treated whey cream was added to 1 liter of skimmed milk) to get a standardized milk with 25.2 g_{fat}/Lₘᵢₗₖ. Alternatively, other % of total fat may be used.

Samples 5.1, 5.2, 5.3 and reference were subsequently pasteurized at 74° for 20 sec. Alternatively, other suitable pasteurization conditions may also be used. Optionally, milk cream can also be added and contribute to the standardization of milk. Upon pasteurization, the samples were used for cheese making, in particular Continental cheese making, wherein Continental cheese may be selected from a list consisting of: Saint-nectaire cheese, Morbier cheese, Chevrotin cheese, Gouda cheese, Raclette cheese, Fontina cheese, Manchego cheese, Cantal cheese, Laguiole cheese, Salers cheese, Cheddar cheese, Abondance cheese, Appenzel cheese, Maasdam cheese, Beaufort cheese, Comté cheese, Parmesan cheese, Grana Padano cheese, Emmental cheese and Gruyère cheese. During the cheese making process, a pasteurization (further pasteurization in the process) of whey can be made to decrease or eliminate residual phospholipase in the whey, if any.

### Fat and Protein Recovery & Cheese Yield

TABLE 8
Percentage of fat recovery, protein recovery and cheese
yield quantification (ECY and MACY) versus the reference.

| | Sample | Sample | Sample |
|---|---|---|---|
| Reference | 5.1 | 5.2 | 5.3 |

At demolding

| | | | | |
|---|---|---|---|---|
| % ECY vs. ref | 0 | −1.5 | 0.1 | −3.7 |
| % MACY vs. ref | 0 | −1.2 | 2.2 | −4.0 |
| % MACY/prot + fat vs. ref | 0 | −1.1 | −0.2 | −3.4 |

Day 21 after demolding

| | | | | |
|---|---|---|---|---|
| Fat recovery | 93.1 | 94.4 | 94.5 | 92.9 |
| Protein recovery | 76.9 | 77.4 | 77.7 | 77.5 |
| % ECY vs. ref | 0 | −2.8 | 1.1 | −2.3 |
| % MACY vs. ref | 0 | −3.3 | 1.0 | −3.2 |
| % MACY/prot + fat vs. ref | 0 | −2.2 | −0.4 | −1.7 |

Table 8 demonstrates the effect of adding phospholipase-treated cream to milk or standardized milk. Table 8 displays:
higher or identical levels of fat and protein were recovered with samples treated with the phospholipase (samples 5.1, 5.2 and 5.3) vs. the reference at day 21 after demolding
an increase in cheese yield when sample 5.2 is used, regardless of the time (demolding or day 21 after demolding).

### Example 5—Addition of Phospholipase to Milk Vs. Whey Cream

Example 5 was carried out to determine cheese yield improvement when a phospholipase (YieldMax® from Chr. Hansen A/S) is added to milk (sample 6.1) as is traditionally made or added to whey cream (sample 6.2), in both cases versus a reference. In both samples (6.1 and 6.2), the phospholipase was added in a concentration of 5 LEU/g of milk fat (or 5 Leu-P/g of milk fat). 4. No phospholipase was added to the reference.

### Fat and Protein Recovery & Cheese Yield

TABLE 9
Percentage of fat recovery, protein recovery and cheese
yield quantification (ECY and MACY) versus the reference.

| | | |
|---|---|---|
| Reference | Sample 6.1 | Sample 6.2 |

At demolding

| | | | |
|---|---|---|---|
| % ECY vs. ref | 0 | 1.9 | 6.3 |
| % MACY vs. ref | 0 | 1.8 | 10.4 |

Day 7 after demolding

| | | | |
|---|---|---|---|
| % ECY vs. ref | 0 | −0.2 | 3.8 |
| % MACY vs. ref | 0 | 0.4 | 10.7 |

Day 21 after demolding

| | | | |
|---|---|---|---|
| % ECY vs. ref | 0 | −0.2 | 6.3 |
| % MACY vs. ref | 0 | 6.3 | 16.1 |

Table 9 shows that adding a phospholipase to whey cream contributes to an increase in cheese yield regardless of the demolding time. Additionally, Table 9 shows an increase in cheese yield when the phospholipase is added to whey cream vs. when it is added directly to milk (as conventionally made).

The data herein shown regarding the residual activity of phospholipase in whey was successfully reproduced in Examples 3 and 5 (sample 6.2)—data not shown, thereby confirming that less phospholipase is obtained in whey when the enzyme is added to whey cream than when it is added directly to milk. Therefore, one of the purposes of this invention (use of a phospholipase in whey cream instead of in milk) leads to the reduction of the residual amount phospholipase in the whey, while simultaneously maintaining or increasing cheese yield.

The present invention has been described with reference to various embodiments, aspects, examples, or the like. It is not intended that these elements be read in isolation from one another. Thus, the present disclosure provides for the combination of two or more of the embodiments, aspects, examples, or the like.

All embodiments described herein are intended to be within the scope of the invention disclosed. These and other embodiments of the present invention will become readily apparent to those skilled in the art from the following detailed description of the preferred embodiments having reference to the whole description, the invention not being limited to any particular preferred embodiment(s) disclosed.

### Sequence Listing

SEQ ID NO: 1
MKFSATILSLLPAVLALPTGEDASVSKRQSVNTVTDQLLFSVTLPQFTAR
RNARDPPTVDWTSDGCTSSPDNPFGFPFIPACNRHDFGYHNYRAQSRFTV
SAKSRIDNNFKTDLYFQCQSSSVSGVCRALADVYFAAVRAFGGDDATPGK
RDEALVKEYEKKVEVYNKLVEEAQKKGDLPRLD

### Numbered Embodiments

### Process

Embodiment 1. Process for making a food product comprising the following steps:
adding a phospholipase to cream and/or whey cream to obtain a phospholipase-treated cream and/or a phospholipase-treated whey cream;
adding the phospholipase-treated cream and/or phospholipase-treated whey cream to milk;
carrying out appropriate steps for preparing the food product.

Embodiment 2. Process according to the previous embodiment, wherein the step of adding the phospholipase-treated cream and/or phospholipase-treated whey cream to milk is carried out by adding 0.2-20.0 g of the phospholipase-treated cream and/or phospholipase-treated whey cream per liter of milk.

Embodiment 3. Process according to any of the previous embodiments, wherein the milk has 90 or less g_{fat}/Lₘᵢₗₖ, preferably wherein the milk has 23-90 g_{fat}/Lₘᵢₗₖ or 23-60 g_{fat}/Lₘᵢₗₖ or 23-30 g_{fat}/Lₘᵢₗₖ g_{fat}/Lₘᵢₗₖ.

Embodiment 4. Process according to any of the previous embodiments, comprising the step of adding 0,3-5,6 g of the phospholipase-treated cream per liter of milk and/or phospholipase-treated whey cream per liter of milk, preferably 0.8-4.2 g of the phospholipase-treated cream per liter of milk and/or phospholipase-treated whey cream per liter of milk, more preferably 1.2-2.4 g of the phospholipase-treated cream per liter of milk and/or phospholipase-treated whey cream per liter of milk.

Embodiment 5. Process according to any of the previous embodiments, wherein the step of adding the phospholipase to cream and/or whey cream is carried out by adding 1-15 Leu/g of fat of the phospholipase to cream and/or whey cream, preferably 2-12 or 2-10 or 2-7 or 3-5 Leu/g of fat of the phospholipase to cream and/or whey cream, more preferably wherein Leu is determined as explained in Specifications prepared at the 65^{th} JECFA 2005, published in the Combined Compendium of Food Additive Specifications, Food and Agriculture Organization of the United Nations JECFA Monographs 1 of 2005.

Embodiment 6. Process according to any of the previous embodiments, wherein the phospholipase is phospholipase A, such as phospholipase A1 (EC 3.1.1.32) or phospholipase A2 (EC 3.1.1.4), preferably wherein the phospholipase has a sequence identity of at least 80% to SEQ ID NO: 1 or has a sequence identity of at least 80% to amino acids 29 to 149 of SEQ ID NO: 1 or has a sequence identity of at least 80% degree of identity to amino acids 29 to 183 SEQ ID NO: 1.

Embodiment 7. Process according to any of the previous embodiments, wherein the process is a batch process or a continuous process.

Embodiment 8. Process according to any of the previous embodiments, wherein the step of adding the phospholipase to cream and/or whey cream is carried out:
at a temperature of 2-10° C., preferably in a batch process; or
at a temperature of 25-42° C., preferably in continuous process.

Embodiment 9. Process according to any of the previous embodiments, comprising a step of heat treating the cream and/or whey cream carried out before the step of adding the phospholipase to the cream and/or whey cream.

Embodiment 10. Process according to any of the previous embodiments, comprising a step of heat-treating the phospholipase-treated cream at 70° C.-90° C., such as 72° C.-87° C. or 82° C.-87° C. or 85° C.-87° C.

Embodiment 11. Process according to any of the previous embodiments, comprising a step of pasteurizing the phospholipase-treated whey cream, the phospholipase-treated cream and/or pasteurizing whey obtained from the process for making a food product, preferably wherein the step of pasteurizing is carried out at 74° C. for 20 sec.

Embodiment 12. Process according to any of the previous claims, wherein the milk is selected from cow's milk, camel's milk, buffalo milk, goat's milk, sheep's milk, and/or a mixture thereof; and/or wherein the milk is skimmed milk; and/or wherein the milk is standardized milk or standardized skimmed milk.

Embodiment 13. Process according to any of the previous embodiments, wherein the food product is a dairy product, preferably a dairy product selected from a cheese, a cheese product, a processed cheese, a cheese-like product, such as vegan cheese or non-dairy cheese, a butter, a yogurt, a cream, and a seasoning, more preferably wherein the dairy product is cheese selected from a list consisting of: Cheddar cheese, Continental cheese, Swiss type cheese, pasta filata, pizza cheese and soft cheese or a list consisting of: pasta filata, Mozzarela cheese, soft cheese, Saint-nectaire cheese, Morbier cheese, Chevrotin cheese, Gouda cheese, Raclette cheese, Fontina cheese, Manchego cheese, Cantal cheese, Laguiole cheese, Salers cheese, Cheddar cheese, Abondance cheese, Appenzel cheese, Maasdam cheese, Beaufort cheese, Comté cheese, Parmesan cheese, Grana Padano cheese, Emmental cheese and Gruyère cheese.

### Uses

Embodiment 14. Use of a phospholipase to improve fat retention and/or protein retention in a process for making a food product, wherein the food product is a dairy product, preferably a dairy product selected from a cheese, a cheese product, a processed cheese, a cheese-like product, such as vegan cheese or non-dairy cheese, a butter, a yogurt, a cream, and a seasoning, more preferably wherein the dairy product is cheese selected from a list consisting of: Cheddar cheese, Continental cheese, Swiss type cheese, pasta filata, pizza cheese and soft cheese or a list consisting of: pasta filata, Mozzarela cheese, soft cheese, Saint-nectaire cheese, Morbier cheese, Chevrotin cheese, Gouda cheese, Raclette cheese, Fontina cheese, Manchego cheese, Cantal cheese, Laguiole cheese, Salers cheese, Cheddar cheese, Abondance cheese, Appenzel cheese, Maasdam cheese, Beaufort cheese, Comté cheese, Parmesan cheese, Grana Padano cheese, Emmental cheese and Gruyère cheese.

Embodiment 15. Use according to the previous embodiment 14, wherein the phospholipase is added to cream and/or whey cream to obtain a treated cream and/or a treated whey cream, preferably wherein 1-15 Leu/g of fat of the phospholipase is added to cream and/or whey cream preferably 2-10 or 2-7 or 3-5 Leu/g of fat of the phospholipase to cream and/or whey cream, more preferably wherein Leu is determined as explained in Specifications prepared at the 65^{th} JECFA 2005, published in the Combined Compendium of Food Additive Specifications, Food and Agriculture Organization of the United Nations JECFA Monographs 1 of 2005.

Embodiment 16. Use according to any of the previous embodiments 14-15, wherein the phospholipase is phospholipase A, or phospholipase A1 (EC 3.1.1.32), or phospholipase A2 (EC 3.1.1.4), preferably wherein the phospholipase has a sequence identity of at least 80% to SEQ ID NO: 1 or has a sequence identity of at least 80% to amino acids 29 to 149 of SEQ ID NO: 1 or has a sequence identity of at least 80% degree of identity to amino acids 29 to 183 SEQ ID NO: 1.

1. A process for making a food product comprising the following steps:
a) adding a phospholipase to whey cream to obtain a phospholipase-treated whey cream;
b) adding the phospholipase-treated whey cream to milk; and
c) processing the milk obtained from the previous step to make the food product.

2. The process according to claim 1, wherein the step of adding the phospholipase-treated whey cream to milk is carried out by adding 0.2-20.0 g of the phospholipase-treated whey cream per liter of milk.

3. The process according to claim 1, wherein the milk has 90 or less g_{fat}/Lₘᵢₗₖ, 23-90 g_{fat}/Lₘᵢₗₖ, 23-60 g_{fat}/Lₘᵢₗₖ, or 23-30 g_{fat}/Lₘᵢₗₖ.

4. The process according to claim 1, comprising the step of adding 0.3-5.6 g of the phospholipase-treated whey cream per liter of milk, 0.8-4.2 g of the phospholipase-treated whey cream per liter of milk, or 1.2-2.4 g of the phospholipase-treated whey cream per liter of milk.

5. The process according to claim 1, wherein the step of adding the phospholipase to whey cream is carried out by adding 1-15, 2-12, 2-10, 2.5-10, 2-7, or 3-5 Leu/g of fat of the phospholipase to whey cream, wherein Leu is determined as explained in Specifications prepared at the 65th JECFA 2005, published in the Combined Compendium of Food Additive Specifications, Food and Agriculture Organization of the United Nations JECFA Monographs 1 of 2005.

6. The process according to claim 1, wherein the phospholipase is phospholipase A.

7. The process according to claim 1, wherein the process is a batch process or a continuous process.

8. The process according to claim 1, wherein the step of adding the phospholipase to whey cream is carried out:
at a temperature of 2-10° C. in a batch process; or
at a temperature of 25-42° C. in continuous process.

9. The process according to claim 1, comprising a step of heat treating the whey cream carried out before the step of adding the phospholipase to the whey cream.

10. The process according to claim 1, comprising a step of pasteurizing the phospholipase-treated whey cream, and/or pasteurizing whey obtained from the process for making a food product.

11. The process according to claim 1, wherein the milk is cow's milk, camel's milk, buffalo milk, goat's milk, sheep's milk, or a mixture thereof; or wherein the milk is skimmed milk; or wherein the milk is standardized milk or standardized skimmed milk.

12. The process according to claim 1, wherein the food product is a dairy product.

13-15. (canceled)

16. The process according to claim 1, wherein the phospholipase is a phospholipase A1 (EC 3.1.1.32) or phospholipase A2 (EC 3.1.1.4).

17. The process according to claim 1, wherein the phospholipase has a sequence identity of at least 80% to SEQ ID NO: 1; a sequence identity of at least 80% to amino acids 29 to 149 of SEQ ID NO: 1; or a sequence identity of at least 80% degree of identity to amino acids 29 to 183 SEQ ID NO: 1.

18. The process according to claim 1, wherein the food product is a dairy product selected from a cheese, a cheese product, a processed cheese, a cheese-like product a butter, a yogurt, a cream, and a seasoning.

19. The process according to claim 1, wherein the food product is a dairy product, wherein the dairy product is cheese selected from pasta filata, Mozzarela cheese, soft cheese, Saint-nectaire cheese, Morbier cheese, Chevrotin cheese, Gouda cheese, Raclette cheese, Fontina cheese, Manchego cheese, Cantal cheese, Laguiole cheese, Salers cheese, Cheddar cheese, Abondance cheese, Appenzel cheese, Maasdam cheese, Beaufort cheese, Comté cheese, Parmesan cheese, Grana Padano cheese, Emmental cheese and Gruyère cheese.
